(19) United States
(12) Patent Application Publication
(10) Pub. No.: US 2020/0004293 A1
(43) Pub. Date: Jan. 2, 2020

(54) HOUSING AND METHOD FOR MANUFACTURING THE HOUSING

(71) Applicants: FIH Precision Electronics (Lang Fang) Co., Ltd., Langfang (CN); FIH (HONG KONG) LIMITED, Kowloon (HK)

(72) Inventors: Yu-Tsai Wang, New Taipei (TW); Jing-Hai Zheng, Shenzhen (CN); Wen-Le Sun, Langfang (CN)

(21) Appl. No.: 16/294,547

(22) Filed: Mar. 6, 2019

(30) Foreign Application Priority Data
Jun. 29, 2018 (CN) 201810711898.1

(51) Int. Cl. G06F 1/16; A45C 13/00

(52) U.S. Cl. CPC G06F 1/1626; A45C 13/002; A45C 2011/002; G06F 1/1698; G06F 1/1656

(57) ABSTRACT

A housing includes a substrate and a plastic part formed on the substrate. The substrate is made of ceramic. A plurality of holes is defined on surfaces of the substrate. The plastic part a plurality micro-structures. The plurality of holes is filled by the plurality micro-structures. A method for manufacturing the housing is provided.

### FIELD

The subject matter herein generally relates to a housing, and a method for manufacturing the housing.

### BACKGROUND

At present, housings of electronic devices such as mobile phones and tablet computers are usually combinations of ceramic and plastic. Generally, ceramic parts and plastic parts are combined by fitting assembly process. However, the fitting assembly processes are cumbersome and require large margin of tolerances.

Therefore, there is room for improvement within the art.

### BRIEF DESCRIPTION OF THE DRAWINGS

Implementations of the present disclosure will now be described, by way of embodiments only, with reference to the attached figures.

FIG. 1 is a diagrammatic view of an embodiment of a housing.

FIG. 2 is an exploded, diagrammatic view of the housing of FIG. 1.

FIG. 3 is an enlarged view of the substrate in circle III line of FIG. 2.

FIG. 4 is an enlarged view of the plastic part in circle IV line of FIG. 2.

FIG. 5 is a flowchart of an embodiment of a method for manufacturing a housing.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

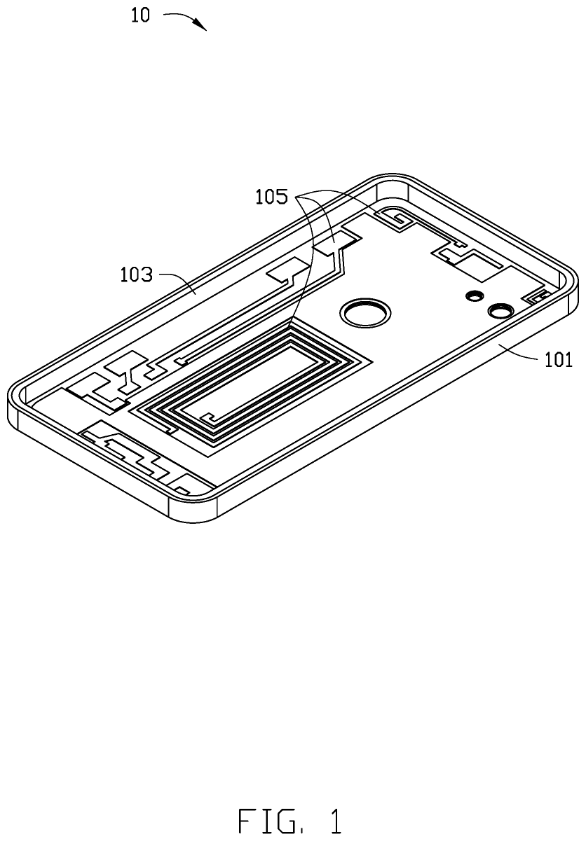

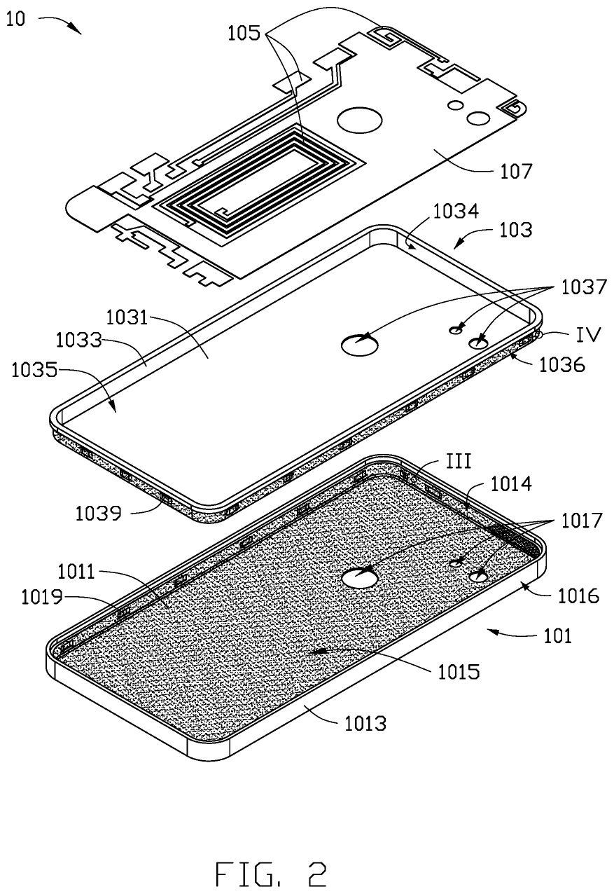

FIG. 1 illustrates an embodiment of a housing 10. The housing 10 may be applied in an electronic device 100 (shown in FIG. 2), such as a mobile phone, a pad or a computer. In at least one embodiment, the electronic device 100 is a mobile phone.

The housing 10 comprises a substrate 101, a plastic part 103 and at least one antenna 105.

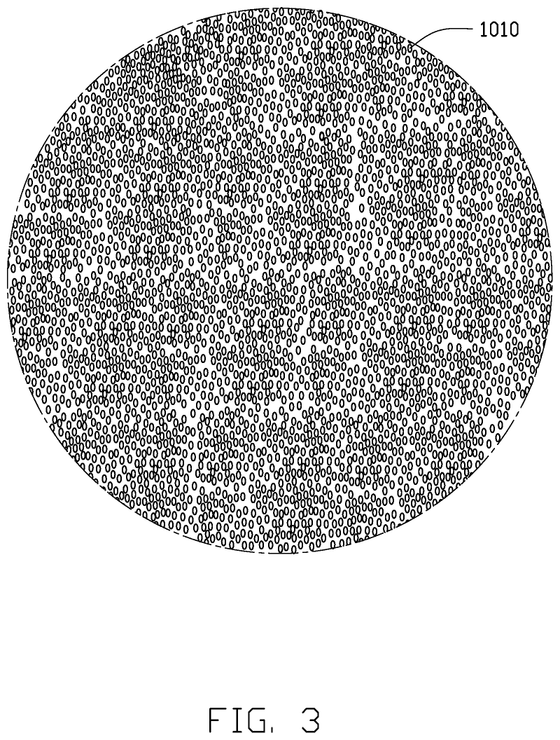

The substrate 101 is made of ceramic. In at least one embodiment, a plurality of holes 1010 (shown in FIG. 3) are defined on surfaces of the substrate 101. Each hole 1010 is substantially circular. Each hole 1010 has a diameter of 1 μm to 8 μm, and a depth of 10 μm to 100 μm.

In at least one embodiment, the holes 1010 is defined by subjecting the substrate 101 to an acid treatment. Specifically, the substrate 101 is immersed in a pickling solution to define the holes 1010 on the surfaces of the substrate 101. In at least one embodiment, the pickling solution may be a hydrofluoric acid solution.

Referring to FIG. 2, the substrate 101 comprises a first baseplate 1011 and a first peripheral wall 1013. The first peripheral wall 1013 is disposed along a periphery of the first baseplate 1011. The first peripheral wall 1013 cooperates with the first baseplate 1011 to define a first receiving portion 1015 with an opening. The plastic part 103 is received in the first receiving portion 1015.

The first peripheral wall 1013 can be disposed along a periphery of the first baseplate 1011 at an angle less than 180°. In at least one embodiment, the first peripheral wall 1013 is perpendicular to the periphery of the first baseplate 1011.

In at least one embodiment, at least one first through-hole 1017 is defined on the substrate 101. The first through-hole 1017 on the first baseplate 1011 may be a camera hole or a flash hole. In at least one embodiment, the first through-hole 1017 may be circular. In another embodiment, the first through-hole 1017 can be varied in shape as needed, such as rectangular and triangular.

In another embodiment, the first through-hole 1017 can also be defined on the first peripheral wall 1013 to accommodate a data line or a headphone jack.

The plastic part 103 matches with the substrate 101 in shape. The plastic part 103 comprises a second baseplate 1031 and a second peripheral wall 1033. The second peripheral wall 1033 is disposed along a periphery of the second baseplate 1031. The second peripheral wall 1033 cooperates with the second baseplate 1031 to define a second receiving portion 1035 with an opening. The antenna 105 is received in second receiving portion 1035.

When the plastic part 103 is received in the first receiving portion 1015, the second baseplate 1031 is attached to the first baseplate 1011, the second peripheral wall 1033 is attached to the first peripheral wall 1013.

At least one second through-hole 1037 is defined on the plastic part 103 corresponding to the at least one first through-hole 1017.

The plastic part 103 may further comprises a plurality of bumps 1039. The second peripheral wall 1033 comprises a second inner surface 1034 and a second outer surface 1036 facing away from the second inner surface 1034. The second inner surface 1034 and the second outer surface 1036 each connects the second baseplate 1031. The second inner surface 1034 faces to the second receiving portion 1035, the second outer surface 1036 faces away from the second receiving portion 1035. The bumps 1039 are formed on a second outer surface 1036 and spaced from each other. Accordingly, the substrate 101 further comprises a plurality of grooves 1019. The first peripheral wall 1013 comprises a first inner surface 1014 and a first outer surface 1016 facing away from the first inner surface 1014. The first inner surface 1014 and the first outer surface 1016 each connects the first baseplate 1011. The first inner surface 1014 faces to the first receiving portion 1015, the first outer surface 1016 faces away from the first receiving portion 1015. The grooves 1019 are defined in the first inner surface 1014, and correspond to the bumps 1039. When the plastic part 103 is received in the first receiving portion 1015, each bump 1039 is embedded in one groove 1019 to enhance a connection strength between the plastic part 103 and the substrate 101.

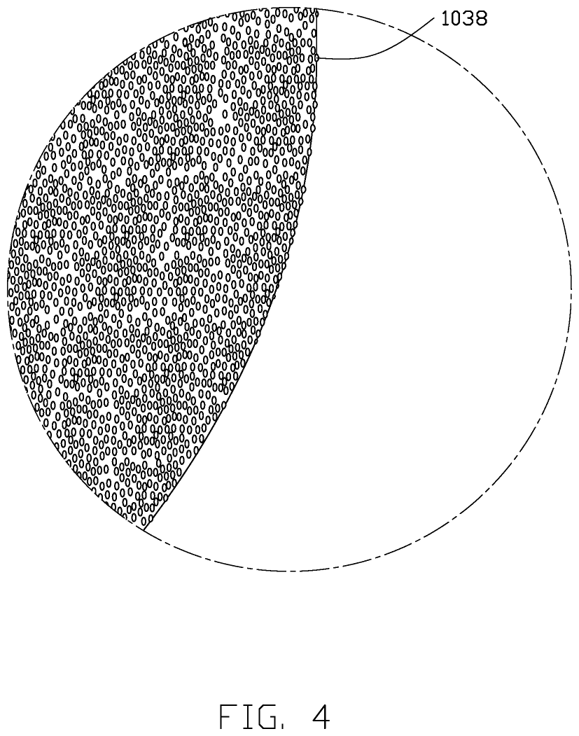

In at least one embodiment, the plastic part 103 is formed on the first inner surface 1014 of the substrate 101 by an injection molding process. Specifically, the substrate 101 is placed in an injection molding mold (not shown), a molten material is injected into the injection molding mold and cured to form the plastic part 103. The molten material fills in the holes 1010 and the grooves 1019 to ensure the plastic part 103 to be firmly formed on the first inner surface 1014 of the substrate 101. The molten material may be selected from a group consisting of polyamide, polyphenylene sulfide, polybutylene terephthalate, polycarbonate, polyvinyl chloride, and any combination thereof. The molten material filling in the grooves 1019 forms the bumps 1039. The molten material filling in the holes 1010 forms a plurality micro-structures 1038 (shown in FIG. 4).

The antenna 105 is located on a surface of the second baseplate 1031 facing away from the first baseplate 1011 for transmitting and receiving signals. In at least one embodiment, the antenna 105 is a Laser Direct Structuring antenna. In another embodiment, the antenna 105 can be made of other materials.

In at least one embodiment, other functional modules such as heat dissipation structure 107 and charging structure (not shown) may be integrated on the surface of the second baseplate 1031 facing away from the first baseplate 1011 as needed, thereby achieving other functions. In one embodiment, the heat dissipation structure 107 is configured to assist an electronic device having the housing 10 to dissipate heat.

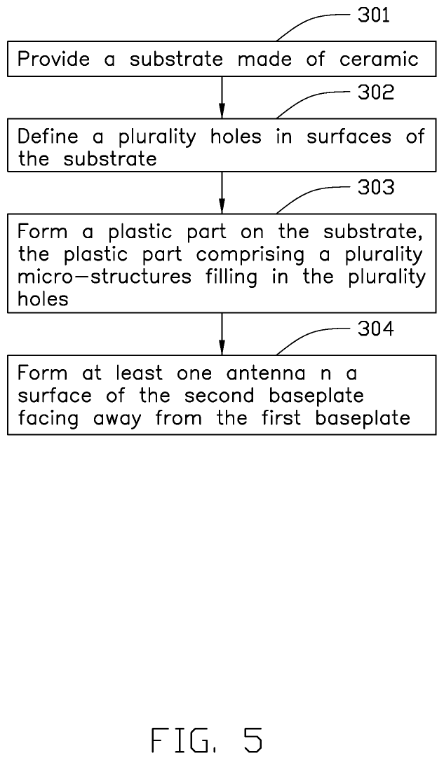

FIG. 5 illustrates a flowchart of a method in accordance with an embodiment. The method for manufacturing a housing is provided by way of embodiments, as there are a variety of ways to carry out the method. Each block shown in FIG. 5 represents one or more processes, methods, or subroutines carried out in the method. Furthermore, the illustrated order of blocks is can be changed. Additional blocks may be added or fewer blocks may be utilized, without departing from this disclosure. The method can begin at block 301.

At block 301, referring to FIG. 2, a substrate 101 is provided. The substrate 101 comprises a first baseplate 1011 and a first peripheral wall 1013. The first peripheral wall 1013 is disposed along a periphery of the first baseplate 1011. The first peripheral wall 1013 cooperates with the first baseplate 1011 to define a first receiving portion 1015 with an opening. In at least one embodiment, the substrate 101 is made of ceramic.

At least one first through-hole 1017 may be defined on the first baseplate 1011 by a Computer Number Control machine to accommodate a camera or a flash. In at least one embodiment, the first through-hole 1017 may be circular. In another embodiment, the first through-hole 1017 can be varied in shape as needed, such as rectangular and triangular.

In another embodiment, the first through-hole 1017 can also be defined on the first peripheral wall 1013 to accommodate a data line or a headphone jack.

The first peripheral wall 1013 comprises a first inner surface 1014 and a first outer surface 1016 facing away from the first inner surface 1014. The first inner surface 1014 and the first outer surface 1016 each connects the first baseplate 1011. The first inner surface 1014 faces to the first receiving portion 1015, the first outer surface 1016 faces away from the first receiving portion 1015. In at least one embodiment, a plurality of grooves 1019 may be defined in the first inner surface 1014 by the Computer Number Control machine.

At block 302, the substrate 101 is subjected by an acid treatment to define a plurality holes 1010 (shown in FIG. 3) on surfaces of the substrate 101.

In at least one embodiment, the substrate 101 is immersed in a pickling solution to define the plurality holes 1010. Each hole 1010 is substantially circular, has a diameter of 1 μm to 8 μm and a depth of 10 μm to 100 μm. In at least one embodiment, the pickling solution may be a hydrofluoric acid solution.

At block 303, a plastic part 103 is formed and received in the first receiving portion 1015.

In at least one embodiment, the substrate 101 is placed in an injection molding mold (not shown), a molten material is injected into the injection molding mold and cured to form the plastic part 103. The molten material fills in the holes 1010 and the grooves 1019 to ensure the plastic part 103 to be firmly formed on the first inner surface 1014 of the substrate 101. The molten material may be selected from a group consisting of polyamide, polyphenylene sulfide, polybutylene terephthalate, polycarbonate, polyvinyl chloride, and any combination thereof. The molten material filling in the holes 1010 forms a plurality micro-structures 1038 (shown in FIG. 4).

As a result, the plastic part 103 matches with the substrate 101 in shape. The plastic part 103 comprises a second baseplate 1031 and a second peripheral wall 1033. The second peripheral wall 1033 is disposed along a periphery of the second baseplate 1031. The second peripheral wall 1033 cooperates with the second baseplate 1031 to define a second receiving portion 1035 with an opening.

At least one second through-hole 1037 is defined on the plastic part 103 corresponding to the at least one first through-hole 1017.

The plastic part 103 may further comprise a plurality of bumps 1039. The bumps 1039 is formed by filling the grooves 1019 with the molten material. The bumps 1039 cooperates with the grooves 1019 to ensure the plastic part 103 to be firmly formed on the substrate 101.

At block 304, at least one antenna 105 is located on a surface of the second baseplate 1031 facing away from the first baseplate 1011.

In at least one embodiment, a laser activating treatment and a chemical activating treatment are applied on a portion of the surface of the second baseplate 1031 to connect the antenna 105. The antenna 105 is formed by metallization of the portion the surface of the second baseplate 1031.

In at least one embodiment, other functional modules such as heat dissipation structure 107 and charging structure (not shown) may be integrated on the surface of the second baseplate 1031 facing away from the first baseplate 1011 as needed, thereby achieving other functions. For example, the heat dissipation structure 107 assists an electronic device having the housing 10 to dissipate heat.

In at least one embodiment, a surface treatment comprising grinding and polishing may be applied on surfaces of the substrate 101 facing away from the first receiving portion 1015, to remove the holes 1010 in the surfaces of the substrate 101 facing away from the first receiving portion 1015. So that the surfaces of the substrate 101 facing away from the first receiving portion 1015 has a specular highlight effect.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A method for manufacturing a housing comprising:
providing a substrate made of ceramic;
defining a plurality of holes on surfaces of the substrate; and
forming a plastic part on the substrate;
wherein the plastic part comprises a plurality micro-structures, each of the plurality of holes is filled by each of the plurality micro-structures.

2. The method for manufacturing the housing of claim 1, wherein each of the plurality of holes is circular.

3. The method for manufacturing the housing of claim 1, the method of defining the plurality of holes comprise immersing the substrate in a pickling solution.

4. The method for manufacturing the housing of claim 3, wherein the pickling solution is a hydrofluoric acid solution.

5. The method for manufacturing the housing of claim 1, wherein each of the plurality of holes has a diameter of 1 μm to 8 μm and a depth of 10 μm to 100 μm.

6. The method for manufacturing the housing of claim 1, further comprising:
forming at least one antenna on a surface of the plastic part facing away from the substrate.

7. The method for manufacturing the housing of claim 1, further comprising:
forming a heat dissipation structure on a surface of the plastic part facing away from the substrate.

8. The method for manufacturing the housing of claim 1, wherein the substrate comprises a first baseplate and a first peripheral wall, the first peripheral wall cooperates with the first baseplate to define a first receiving portion, the plurality of holes is defined on the surfaces of the first peripheral wall facing the first receiving portion, the plastic part is received in the first receiving portion.

9. The method for manufacturing the housing of claim 8, wherein the plastic part matches with the substrate in shape.

10. The method for manufacturing the housing of claim 9, wherein the substrate comprises a plurality of grooves spacing from each other, the plastic part further comprises a plurality of bumps corresponding to the plurality of grooves, each of the plurality of bumps is embedded into a corresponding one of the plurality of grooves.

11. A housing comprising:
a substrate made of ceramic; and
a plastic part formed on the substrate;
wherein a plurality of holes is defined on surfaces of the substrate, the plastic part comprises a plurality micro-structures, the plurality of holes is filled by the plurality micro-structures.

12. The housing of claim 11, wherein each of the plurality of holes is circular.

13. The housing of claim 11, wherein each of the plurality of holes has a diameter of 1 μm to 8 μm and a depth of 10 μm to 100 μm.

14. The housing of claim 11, wherein the housing further comprises at least one antenna, the at least one antenna is formed on a surface of the plastic part facing away from the substrate.

15. The housing of claim 11, wherein the housing further comprises a heat dissipation structure, the heat dissipation structure is formed on a surface of the plastic part facing away from the substrate.

16. The housing of claim 11, wherein the substrate comprises a plurality of grooves spaced from each other, the plastic part further comprises a plurality of bumps corresponding to the plurality of grooves, each of the plurality of bumps is embedded into a corresponding one of the plurality of grooves.
